(19) United States
(12) Patent Application Publication
(10) Pub. No.: US 2023/0017451 A1
(43) Pub. Date: Jan. 19, 2023

(54) SYSTEMS AND METHODS FOR DELIVERING CONTENT TO DEVICES OVER A NETWORK BASED ON ATTRIBUTE CLUSTERS

(71) Applicant: Lotame Solutions, Inc., Columbia, MD (US)

(72) Inventors: Omar Abdala, Ann Arbor, MI (US); Pierre-Marc Diennet, New York, NY (US); Andrew Conant, Nathrop, CO (US); John Stuckey, Baltimore, MD (US)

(21) Appl. No.: 17/863,958

(22) Filed: Jul. 13, 2022

Related U.S. Application Data
(60) Provisional application No. 63/221,736, filed on Jul. 14, 2021.

(51) Int. Cl. G06Q 30/02; G06F 16/28; H04L 67/146

(52) U.S. Cl. CPC G06Q 30/0255; G06F 16/285; H04L 67/146

(57) ABSTRACT

Content can be delivered to devices via one or more networks based on clusters of attributes in some examples. As one particular example, a server can determine a first set of attributes corresponding to a cookie associated with an entity and determine a second set of attributes corresponding to a mobile advertiser identifier (MAID) associated with the entity. The server can generate a cluster of attributes for the entity based on the first set of attributes and the second set of attributes. The system can then receive audience definition criteria defining a target audience for content and determine whether the cluster of attributes satisfies the audience definition criteria. If the cluster of attributes satisfies the audience definition criteria, the server can designate the cookie and the MAID as belonging to the target audience to enable the content to be delivered to the entity.

### REFERENCE TO RELATED APPLICATIONS

This application claims priority to U.S. Provisional Patent Application No. 63/221,736, titled “SYSTEMS AND METHODS FOR DELIVERING CONTENT TO DEVICES OVER A NETWORK BASED ON ATTRIBUTE CLUSTERS,” filed Jul. 14, 2021, the entirety of which is hereby incorporated by reference.

### TECHNICAL FIELD

The present disclosure generally relates to content delivery via a network such as the Internet. More specifically, but not by way of limitation, this disclosure relates to delivering content to devices over one or more networks based on attribute clusters.

### BACKGROUND

It has become commonplace for a single entity (e.g., user or household) to have multiple devices that can access websites and other content on the Internet. For example, a single user may have a laptop computer, desktop computer, mobile phone, tablet, smart watch, e-reader, and other user devices through which the user accesses content on the Internet. The user may also have Internet of Things (IOT) devices, such as smart appliances like refrigerators, ovens, and microwaves, that can access content on the Internet. As the devices access websites on the Internet, cookies may be stored on the devices for authentication purposes and other purposes. Each device may have a unique cookie stored thereon, such that a large number of cookies corresponding to the same entity are distributed among multiple devices. Additionally or alternatively to cookies, other means may also be used to uniquely identify the devices or the entity for authentication and other purposes. For example, the devices or applications executing thereon may have corresponding session identifiers, cookie identifiers, or other unique identifiers usable to uniquely identify the device or the entity. As a result, there can be a large number of disparate cookies and other unique identifiers corresponding to a single entity.

### BRIEF DESCRIPTION OF DRAWINGS

A full and enabling disclosure is set forth more particularly in the remainder of the specification. The specification makes reference to the following appended figures.

FIG. 1 shows a block diagram of an example of a system according to some aspects of the present disclosure.

FIG. 2 shows a flow chart of an example of a process for generating clusters of attributes according to some aspects of the present disclosure.

FIG. 3 shows an example of a portion of a database according to some aspects of the present disclosure.

FIG. 4 shows a flow chart of an example of a process for comparing audience definition criteria to a cluster of attributes according to some aspects of the present disclosure.

FIG. 5 shows a block diagram of an example of a server according to some aspects of the present disclosure.

### DETAILED DESCRIPTION

Examples are described herein in the context of systems and methods for delivering content to devices over networks based on clustered attributes. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made, such as to comply with application-related constraints.

Users access the Internet for a variety of reasons, for example to view websites and other content. In a typical scenario, the same entity (e.g., user or group of users) can have various devices usable to access websites and servers. For example, the same entity can browse websites using the entity's smart phone, smart watch, laptop computer, and tablet. As the devices access the Internet, a unique identifier may be generated for the device or the entity. Examples of the unique identifier can include a cookie (e.g., a first party cookie or a third party cookie), a mobile advertiser identifier (MAID) such as GAID and IDFA, a proprietary identifier such as LiveRamp® Unified ID, an android device identifier such as GPS ADID, etc. Attributes relating to the device or the entity can be then collected over time by servers and stored in a database in relation to the corresponding unique identifier. These stored attributes can be used by the same servers or different servers to engage in authentication, marketing, and other operations.

In the above scenario, the attributes are collected and stored separately for each unique identifier associated with the entity. This leads to fragmented information about the entity, given that the attributes are spread across multiple unique identifiers. This can make it challenging to effectively perform the abovementioned operations. For example, a server may perform an authentication operation using only the attributes corresponding to a particular unique identifier. But because those attributes are limited and do not paint a complete picture of the entity, the server may improperly reject the entity's attempt to authenticate with the server. This may prevent the entity from accessing his account. As another example, a server may perform a marketing operation using only the attributes corresponding to a particular unique identifier. But because those attributes are limited and do not paint a complete picture of the entity, the server may fail to recognize the entity as belonging to a target audience. As a result, the server may not deliver certain content (e.g., a video or banner) to the entity, may deliver the wrong content to the entity, or may deliver suboptimal content to the entity.

In addition to the above problems, separately storing the attributes for each individual unique identifier can result in the consumption of significant amounts of computing resources (e.g., memory, processing power, and bandwidth). For example, this approach can consume a significant amount of memory, because duplicates of the same attributes may be stored in a database in relation to the different unique identifiers corresponding to the same entity. As another example, this approach can also increase consumption of processing power and increase the latency of the system, because each set of attributes corresponding to each unique identifier may need to be separately processed and analyzed to perform an authentication operation or another operation, despite there being significant overlaps between the sets of attributes. As yet another example, this approach may waste bandwidth and other network resources due to repeated login attempts resulting from failed authentication operations. This approach could also waste bandwidth and other network resources due to suboptimal content being transmitted to the entity.

Some examples of the present disclosure can overcome one or more of the abovementioned problems via a server that can receive multiple sets of attributes corresponding to multiple unique identifiers associated with one or more devices (e.g., computing devices) of an entity. The server can then aggregate the multiple sets of attributes together into a single cluster of attributes for the entity. Aggregating the multiple sets of attributes together may involve excluding duplicates of the same attributes from the cluster of attributes. Using the cluster of attributes, the server can then perform one or more of the abovementioned computing operations. Because the cluster of attributes is a more holistic (e.g., unified) collection of attributes associated with the entity, using the cluster of attributes to perform the computing operations can lead to greater efficiency and accuracy, which in turn may reduce the latency and bandwidth consumption of the system. And because the computing operations are performed using the cluster of attributes that excludes duplicate attributes, memory and processing power may be conserved.

This illustrative example is given to introduce the reader to the general subject matter discussed herein and the disclosure is not limited to this example. The following sections describe various additional non-limiting examples.

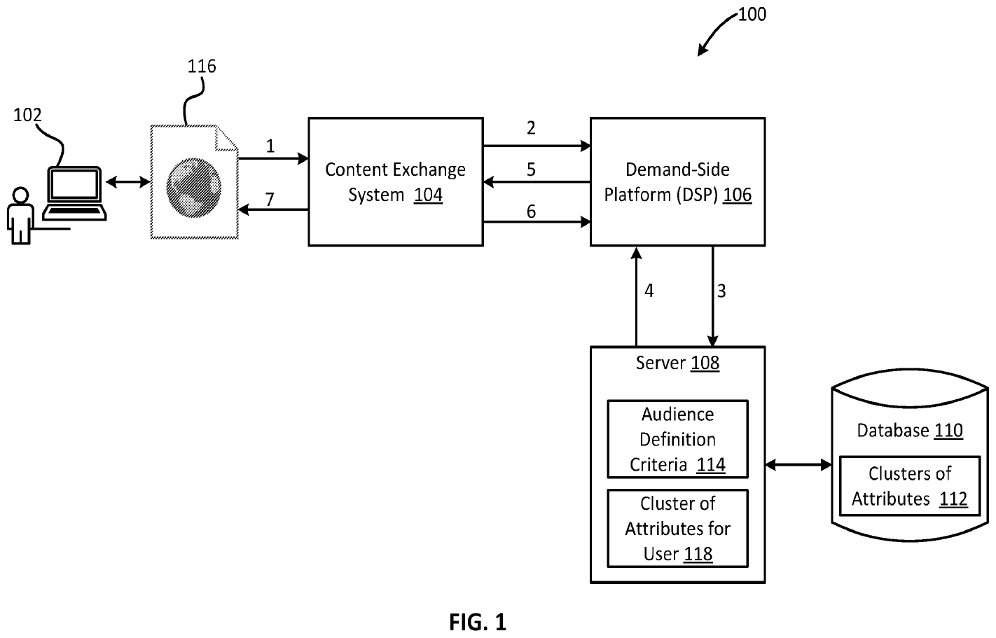

FIG. 1 shows a block diagram of an example of a system 100 for implementing a sequence of operations for delivering content according to some aspects of the present disclosure. In this example, the system 100 includes a device 102, such as a laptop computer, desktop computer, mobile phone, or another computing device. An entity can operate the device 102 to browse websites on the Internet. For example, a user may operate a website browser such as Apple Safari® or Internet Explorer® on the device 102 to browse websites. Upon the device 102 navigating to a webpage 116, the sequence of operations can begin. The sequence of operations will now be described below with reference to numbers 1-7 shown in FIG. 1.

At step 1, a web server hosting the webpage 116 determines that the device 102 is attempting to access the webpage 116 and responsively transmits a content request to a content exchange system 104. One example of the content request can be an ad request and one example of the content exchange system 104 can be an ad exchange system.

The content request can include session information relating to the entity accessing the webpage 116. The session information can include information about the entity, the device 102, the webpage 116, or any combination of these. For example, the session information can include cookie data relating to a cookie stored on the device 102. A cookie is a text file with data used to identify a device or an entity. An example of a cookie can be a HTTP cookie. The session information may additionally or alternatively include a MAID associated with the device 102. A MAID can be a sequence of symbols (e.g., letters and numbers) generated by the operating system of a device to identify the device or an entity.

The content exchange system 104 can receive the content request and responsively transmit an offer request to a demand-side platform (DSP) 106 at step 2. The offer request can include some or all of the session information. Although only one DSP 106 is shown in FIG. 1 for simplicity, other examples can include multiple DSPs that are each transmitted a respective offer request from the content exchange system 104.

Each DSP can have corresponding audience definition criteria (ADC), which includes one or more criterion that define a target audience for content associated with that particular DSP. The ADC can corresponding to each DSP can define the target audience of the DSP in any suitable manner, for example using logic statements describing attributes of the target audience.

The DSP 106 can receive the offer request and responsively transmit a matching request to a server 108 at step 3. The matching request can be configured to cause the server 108 to determine whether the entity operating the device 102 matches the ADC 114 of the DSP 106. The matching request includes some or all of the session information. The matching request may also include the ADC 114 of the DSP 106. Alternatively, the DSP 106 can provide the ADC 114 to the server 108 separately from the matching request.

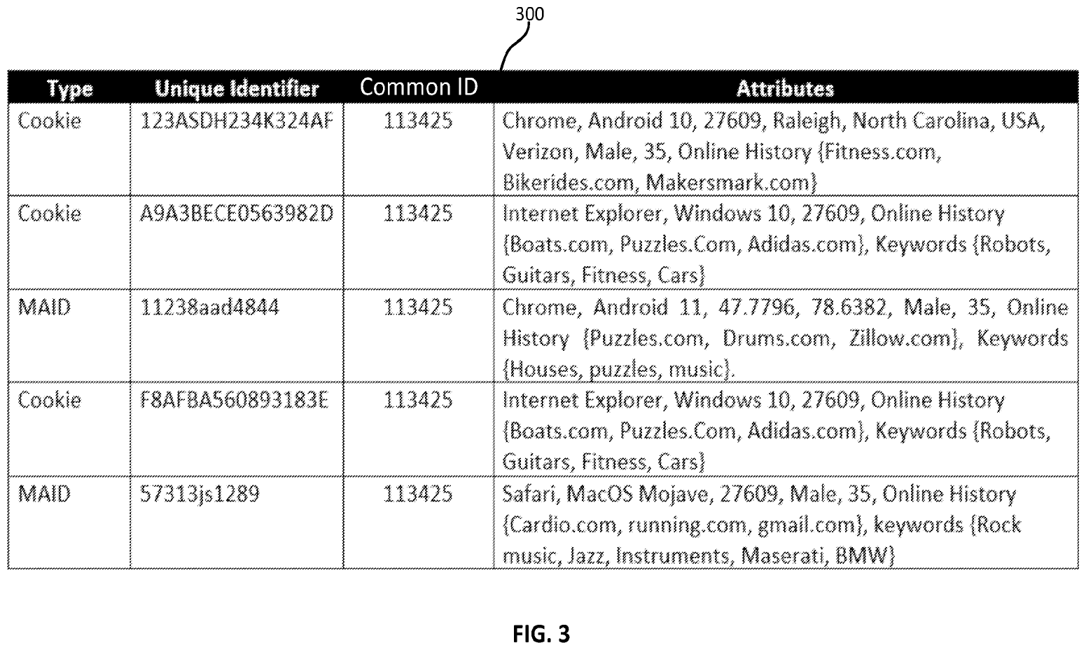

The server 108 can receive the matching request and responsively determine a cluster of attributes 118 that corresponds to the entity. For example, the server 108 can extract a unique identifier (e.g., cookie data or a MAID) from the matching request; determine that the unique identifier is associated with a particular entity identifier in a database, such as the database 300 of FIG. 3; and then determine which cluster of attributes 118 is associated the particular entity identifier in one or more databases 110. The database 110 can include multiple clusters of attributes 112, where each cluster of attributes corresponds to an individual entity. Using this approach, the server 108 can identify the cluster of attributes 118 that corresponds to the entity from among the multiple clusters of attributes 112 in the database 110. Other approaches may additionally or alternatively be used to identify the cluster of attributes 118 that corresponds to the entity. The cluster of attributes 118 corresponding to the entity may include any number and combination of attributes, such as a name, birthdate, user agent, IP address, and/or keyword associated with the entity.

Having identified the cluster of attributes 118 corresponding to the entity, the server 108 can next compare the ADC 114 to the cluster of attributes 118 to determine whether the cluster of attributes 118 satisfies the ADC 114. If the cluster of attributes 118 satisfies the ADC 114, then the entity of the device 102 can be considered to satisfy the ADC 114.

As will be described in greater detail below, the cluster of attributes 118 may have been previously generated by the server 108, for example by aggregating together two or more sets of attributes corresponding to two or more unique identifiers (e.g., cookie identifiers, MAIDs, etc.) associated with the entity. The unique identifiers may correspond to the same device 102 or different devices associated with the entity. If the server 108 determines that the cluster of attributes 118 satisfies the ADC 114, the server 108 may designate some or all of the unique identifiers associated with the cluster of attributes 118 as belonging to the target audience of the DSP 106. If the server 108 determines that the cluster of attributes 118 does not satisfy the ADC 114, the server 108 may designate some or all of the unique identifiers associated with the cluster of attributes 118 as not belonging to the target audience of the DSP 106. Designating some or all of the unique identifiers associated with the cluster of attributes 118 as belonging or not belonging to the target audience approach can prevent the server 108 from duplicating processing work. For example, if the entity accesses the webpage 116 again using another application (e.g., another website browser) on the same device 102 or using another device, the unique identifiers associated with the other application or the other device will have already been qualified as belonging to the target audience or not belonging to the target audience, so that the server 108 does not need to expend additional computing resources to separately making that determination. This can conserve a significant amount of processing power and memory, among other computing resources.

At step 4, the server 108 transmits a match response to the DSP 106. The match response can indicate whether the entity satisfies the ADC 114. Based on the match response, the DSP 106 can take appropriate action. For example, if the match response indicates that the entity satisfies the ADC 114, then the DSP 106 can transmit an offer response to the content exchange system 104 at step 4. The offer response may include the target content (e.g., an ad) to be delivered to the device 102 and an offer amount. If the match response indicates that the entity does not satisfy the ADC 114, then the DSP 106 can forego transmitting an offer response to the content exchange system 104.

The content exchange system 104 can receive offer responses from multiple DSPs and select a winning offer. If the selected offer belongs to DSP 106, the content exchange system 104 can transmit a win notice to the DSP 106 indicating that its offer was accepted at step 6. The content exchange system 104 can also transmit the target content to the webserver hosting the webpage 116 at step 7, so that the target content can be integrated into the webpage 116 for display to the entity associated with the device 102.

It will be appreciated that although FIG. 1 shows a certain number and arrangement of components, this is intended to be illustrative and non-limiting. Other examples may include more components, fewer components, different components, or a different arrangement of the components shown in FIG. 1. For instance, other examples may involve multiple devices of the same type or different types associated with the same entity or different entities. Additionally, the sequence of operations described above is intended to be illustrative and non-limiting. Other examples may include more steps, fewer steps, different steps, or a different order of the steps shown in FIG. 1.

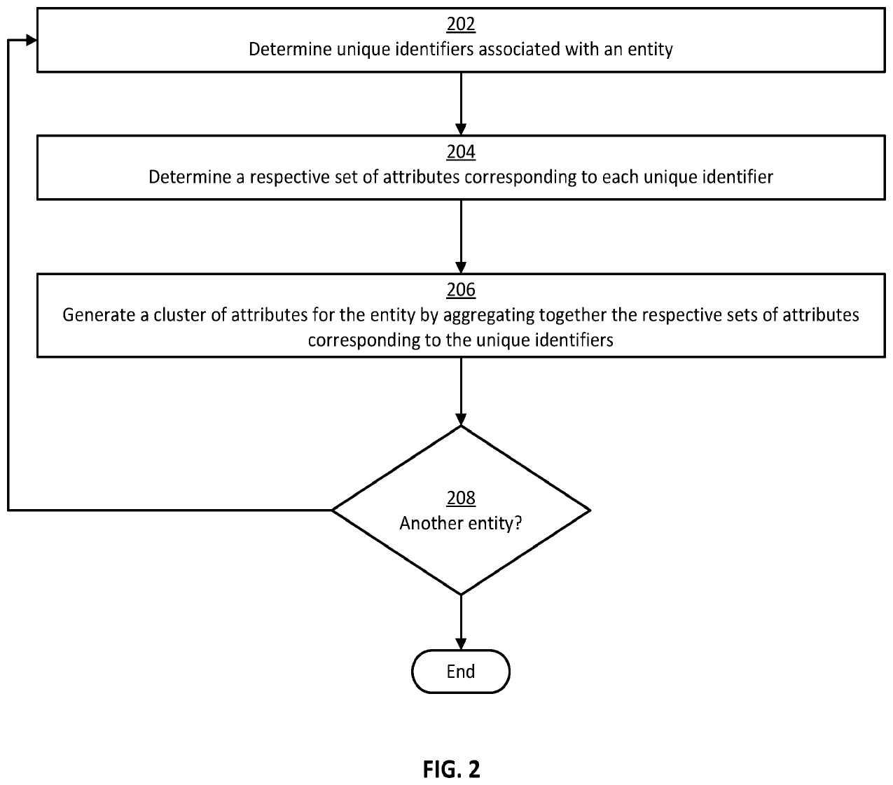

FIG. 2 shows a flow chart of an example of a process for generating clusters of attributes according to some aspects of the present disclosure. Other examples can include more steps, fewer steps, different steps, or a different order of the steps than is shown in FIG. 2. The steps of FIG. 2 are discussed below with reference to the components discussed above in relation to FIG. 1.

At step 202, the server 108 determines multiple unique identifiers that are associated with an entity (the same entity). The server 108 can determine the unique identifiers that are associated with the entity by accessing one or more databases. One example of a database 300 is shown in FIG. 3. As shown, the database 300 includes unique identifiers in the “unique identifier” column. The unique identifiers can be of the same type or of different types, such as a cookie identifier and a MAID, as designated in the “type” column. It will be appreciated that FIG. 3 only shows a small number of rows corresponding to a single entity for simplicity. Other examples may have significantly more rows than are shown in FIG. 3 corresponding to multiple entities. For instance, other examples may involve, for example, tens of millions of rows associated with millions of entities. Additionally, other examples can include more, fewer, different, or a different arrangement of columns or data storage structures than are shown in FIG. 3.

As shown in FIG. 3, the unique identifiers for a given entity can each be assigned the same overall entity ID for the entity. This overall entity ID can be referred to as a “common ID,” since it is the same among all of the unique identifiers for the entity. The common ID may be a sequence of symbols usable to link together all of the individual unique identifiers for a particular entity. One example of a common ID is shown in the “Common ID” column of FIG. 3. In this example, all of the unique identifiers belong to the same entity and are thus correlated to the same common ID of 113425.

To determine how to group unique identifiers, a trained machine-learning model may be used. Examples of the trained machine-learning model can include a neural network or classifier. In some examples, the trained machine-learning model can receive attributes associated with an entity identifier as input, identify a corresponding common ID based on the input attributes, and provide the corresponding common ID as output. This can allow for the unique identifier to be assigned a common ID, which in turn can link the unique identifier to other unique identifiers associated with a particular entity.

The database 300 may be generated by the server 108 and/or one or more additional servers. For example, a group of servers can collect and store information about entities as they browse websites or perform other operations on the Internet. The group of servers can gather information about each entity's browsing history, unique identifiers, and/or attributes for use in populating the database 300. The group of servers may then populate the database 300 with that information or transmit that information to the server 108, which can format (e.g., normalize) and store the information in the database 300. The group of servers can also assign common IDs to the unique identifiers in the database 300, for example by using the trained machine-learning model described above.

At step 204, the server 108 determines a respective set of attributes corresponding to each unique identifier associated with the entity. The server 108 may determine which unique identifiers in the database 300 belong to the entity based on the common IDs assigned to each unique identifier in the database 300. For example, the server 108 can access the database 300 and determine that the unique identifier “123ASDH234K324AF” in the first database row belongs to the entity, since it has the common ID for the entity. The server 108 can then to obtain the set of attributes corresponding to that unique identifier. The server 108 can repeat this process to obtain each respective set of attributes corresponding to each unique identifier associated with the entity. Examples of the attributes can include an application name, such as the name of a website browser used to store a cookie; a timestamp, such as the last time the unique identifier was used; a user agent; a device make and/or model of a device associated with the unique identifier; an operating system of a device associated with the unique identifier; a language, such as a language spoken by the user; GPS coordinates (e.g., latitude, longitude); a location such as a country and/or zip code; an IP address, telecommunications carrier, or other network information; demographic information such as age, sex, or income; preferences or settings; Internet historical information (e.g., websites previously visited); keywords, such as search terms used in performing Internet searches; or any combination of these.

At step 206, the server 108 generates a cluster of attributes 118 for the entity by aggregating together the respective sets of attributes corresponding to the unique identifiers. For example, the server 108 can combine together some or all of the attributes shown in FIG. 3 into the cluster of attributes 118. The server 108 may also remove any duplicate attributes from the cluster of attributes 118. After generating the cluster of attributes 118, the server 108 can then store the cluster of attributes 118, for example in database 110 of FIG. 1. The cluster of attributes 118 can be related in the database 110 to the entity. For example, the database 110 can include an association between the cluster of attributes 118 and the entity ID of the entity, so that the cluster of attributes 118 can be easily identified as belonging to the entity in subsequent operations.

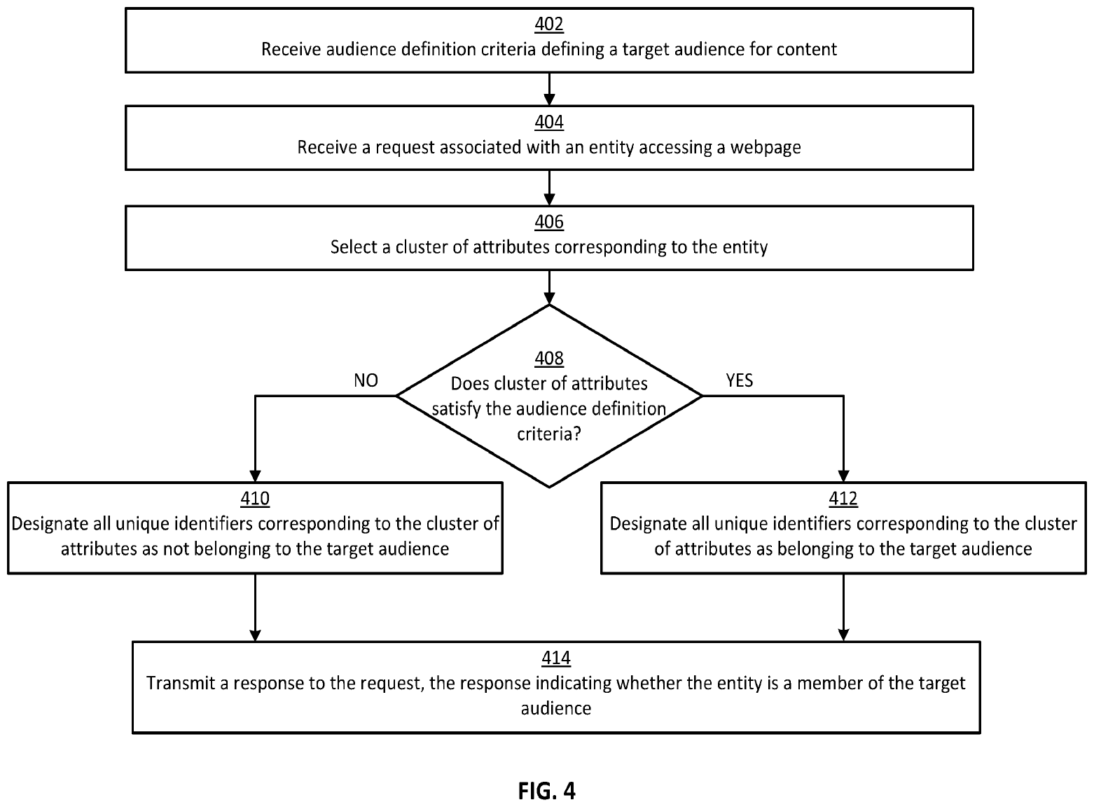

At step 208, the server 108 determines if there is another entity for which a cluster of attributes is to be generated. If so, the process can return to step 202 and repeat for the next entity. Otherwise, the process can end. After the clusters of attributes 112 have been generated for the one or more entities, the server 108 can store and then use the clusters of attributes 112 to perform one or more computing operations, such as the operations shown in FIG. 4.

Referring now to FIG. 4, FIG. 4 shows a flow chart of an example of a process for comparing audience definition criteria to a cluster of attributes according to some aspects of the present disclosure. Other examples can include more steps, fewer steps, different steps, or a different order of the steps than is shown in FIG. 4. The steps of FIG. 4 are discussed below with reference to the components discussed above in relation to FIG. 1.

At step 402, the server 108 receives ADC 114 defining a target audience for content. The server 108 can receive the ADC 114 from a client device, such as DSP 106 or another source.

At step 404, the server 108 receives a request associated with an entity accessing a webpage 116. The server 108 can receive the request from a client device, such as the content exchange system 104 or another source. An example of the request may be the matching request described above. The request can include a unique identifier (e.g., a cookie or MAID) associated with the entity.

At step 406, the server 108 selects a cluster of attributes 118 corresponding to the entity. The server 108 may select the cluster of attributes 118 based on information included in the request, such as a unique identifier included in the request. In one such example, the server 108 can access a first database such as database 300 shown in FIG. 3 to determine which entity ID corresponds to the unique identifier included in the request. The server 108 can then access a second database 110 to correlate the entity ID to a particular cluster of attributes 118.

At step 408, the server 108 determines whether the cluster of attributes 118 satisfies the ADC 114. This may involve applying logic statements in the ADC 114 to the attributes in the cluster to determine whether the attributes satisfy the logic statements. As one particular example, the ADC 114 may define the target audience as users that are “male AND 35+ AND keywords{guitars}.” This may mean that the target audience is males that are over age 35 and that are interested in or otherwise associated with guitars. Such a target audience may be appropriate, for example, if the content for the target audience relates to rare vintage guitars from the 1970s. The server 108 can analyze the cluster of attributes to determine whether the cluster of attributes 118 satisfies all three of those requirements (e.g., the cluster of attributes 118 indicates that the user is male, over age 35, and interested in guitars).

If the server 108 determines that the cluster of attributes 118 does not satisfy the ADC 114, then the process can proceed to step 410 where server 108 can designate all unique identifiers corresponding to the cluster of attributes 118 as not belonging to the target audience. For example, the server 108 may store flags in association with the unique identifiers to indicate that they do not belong to the target audience. If the server 108 determines that the cluster of attributes 118 does satisfy the ADC 114, then the process can proceed to step 412 where server 108 can designate all unique identifiers corresponding to the cluster of attributes 118 as belonging to the target audience. For example, the server 108 may store flags in association with the unique identifiers to indicate that they belong to the target audience. By storing the flags, the next time the server 108 receives a request associated with any of the unique identifiers of the associated with the cluster of attributes 118, the server 108 can quickly determine whether or not the unique identifier belongs to the target audience without having to perform step 408 again. This can conserve computing resources and reduce the latency of the system.

At step 414, the server 108 transmits a response indicating whether the entity is a member of the target audience. The server 108 can transmit the response to the client device that transmitted the request in step 404.

The above process can be repeated any number of times for any number of entities in relation to one or more sets of audience definition criteria.

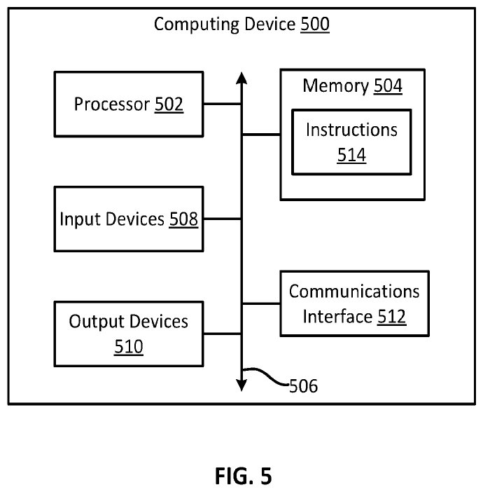

Some or all of the processes described above may be implemented using a computing device, such as the computing device 500 of FIG. 5. The computing device 500 may correspond to the server 108 described above with respect to FIG. 1. The computing device 500 includes a processor 502 that is in communication with the memory 504 and other components of the computing device 500 using one or more communications buses 506. The processor 502 is configured to execute processor-executable instructions 514 stored in the memory 504 to perform one or more processes for delivering content to devices over one or more networks based on clusters of attributes.

As shown, the computing device 500 also includes one or more user input devices 508 (e.g., keyboard, mouse, touchscreen, video capture device, and/or microphone) to accept user input. The computing device 500 also includes one or more display devices 510 to provide visual output to a user.

The computing device 500 further includes a communications interface 512. In some examples, the communications interface 512 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For instance, some examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a videoconferencing server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The above description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations thereof in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A server comprising:
a processor; and
a memory including program code that is executable by the processor to cause the processor to:
determine a first set of attributes corresponding to a cookie associated with an entity;
determine a second set of attributes corresponding to a mobile advertiser identifier (MAID) associated with the entity;
generate a cluster of attributes for the entity based on the first set of attributes corresponding to the cookie and the second set of attributes corresponding to the MAID;
receive audience definition criteria defining a target audience for content;
determine whether the cluster of attributes satisfies the audience definition criteria; and
in response to determining that the cluster of attributes satisfies the audience definition criteria, designate the cookie and the MAID as belonging to the target audience to enable the content to be delivered to the entity.

2. The server of claim 1, wherein the memory further includes program code that is executable by the processor to cause the processor to:
determine a plurality of cookies associated with the entity;
for each cookie in the plurality of cookies, determine a respective set of attributes corresponding to the cookie and incorporate the respective set of attributes into the cluster of attributes; and
in response to determining that the cluster of attributes satisfies the audience definition criteria, designate all cookies in the plurality of cookies as belonging to the target audience.

3. The server of claim 2, wherein the memory further includes program code that is executable by the processor to cause the processor to:
determine a plurality of MAIDs associated with the entity;
for each MAID in the plurality of MAIDs, determine a respective set of attributes corresponding to the MAID and incorporate the respective set of attributes into the cluster of attributes; and
in response to determining that the cluster of attributes satisfies the audience definition criteria, designate all MAIDs in the plurality of MAIDs as belonging to the target audience.

4. The server of claim 1, wherein the cookie or the MAID corresponds to a device of the entity, and wherein the memory further includes program code that is executable by the processor to cause the processor to:
receive a request from a client device, wherein the request is associated with the entity accessing a webpage using the client device; and
in response to receiving the request:
determine that the cluster of attributes associated with the entity satisfies the audience definition criteria; and
based on determining that cluster of attributes associated with the entity satisfies the audience definition criteria, transmit a response to the client device indicating that the cookie and/or the MAID belongs to the target audience.

5. The server of claim 1, wherein the memory further includes program code that is executable by the processor to cause the processor to:
receive a plurality of clusters of attributes corresponding to a plurality of entities, wherein each cluster of attributes in the plurality of clusters of attributes corresponds to a respective entity in the plurality of entities and includes an aggregated set of attributes generated from subsets of attributes corresponding to respective cookies and MAIDs associated with the respective entity, and wherein the plurality of clusters of attributes includes a first cluster of attributes corresponding to the entity and a second cluster of attributes corresponding to another entity;
analyze each cluster of attributes in the plurality of clusters of attributes to determine whether the cluster of attributes satisfies the audience definition criteria; and
based on analyzing each cluster of attributes in the plurality of clusters of attributes:
determine that the second cluster of attributes corresponding to the other entity does not satisfy the audience definition criteria; and
based on determining that the second cluster of attributes does not satisfy the audience definition criteria, designate the respective cookies and MAIDS associated with the second cluster of attributes as not belonging to the target audience.

6. The server of claim 1, wherein the audience definition criteria includes one or more logic statements defining one or more attributes of the target audience.

7. A method comprising:
determining, by a processor, a first set of attributes corresponding to a cookie associated with an entity;
determining, by the processor, a second set of attributes corresponding to a mobile advertiser identifier (MAID) associated with the entity;
generating, by the processor, a cluster of attributes for the entity based on the first set of attributes corresponding to the cookie and the second set of attributes corresponding to the MAID;
receiving, by the processor, audience definition criteria defining a target audience for content;
determining, by the processor, whether the cluster of attributes satisfies the audience definition criteria; and
in response to determining that the cluster of attributes satisfies the audience definition criteria, designating, by the processor, the cookie and the MAID as belonging to the target audience to enable the content to be delivered to the entity.

8. The method of claim 7, further comprising:
determining, by the processor, a plurality of cookies associated with the entity;
for each cookie in the plurality of cookies, determining, by the processor, a respective set of attributes corresponding to the cookie and incorporate the respective set of attributes into the cluster of attributes; and
in response to determining that the cluster of attributes satisfies the audience definition criteria, designating, by the processor, all cookies in the plurality of cookies as belonging to the target audience.

9. The method of claim 8, further comprising:
determining, by the processor, a plurality of MAIDs associated with the entity;
for each MAID in the plurality of MAIDs, determining, by the processor, a respective set of attributes corresponding to the MAID and incorporating the respective set of attributes into the cluster of attributes; and
in response to determining that the cluster of attributes satisfies the audience definition criteria, designating, by the processor, all MAIDs in the plurality of MAIDs as belonging to the target audience.

10. The method of claim 7, wherein the cookie or the MAID corresponds to a device of the entity, and further comprising:
receiving, by the processor, a request from a client device, wherein the request is associated with the entity accessing a webpage using the client device; and
in response to receiving the request:
determining, by the processor, that the cluster of attributes associated with the entity satisfies the audience definition criteria; and
based on determining that cluster of attributes associated with the entity satisfies the audience definition criteria, transmitting, by the processor, a response to the client device indicating that the cookie and/or the MAID belongs to the target audience.

11. The method of claim 7, further comprising:
receiving, by the processor, a plurality of clusters of attributes corresponding to a plurality of entities, wherein each cluster of attributes in the plurality of clusters of attributes corresponds to a respective entity in the plurality of entities and includes an aggregated set of attributes generated from subsets of attributes corresponding to respective cookies and MAIDs associated with the respective entity, and wherein the plurality of clusters of attributes includes a first cluster of attributes corresponding to the entity and a second cluster of attributes corresponding to another entity;
analyzing, by the processor, each cluster of attributes in the plurality of clusters of attributes to determine whether the cluster of attributes satisfies the audience definition criteria; and
based on analyzing each cluster of attributes in the plurality of clusters of attributes:
determining, by the processor, that the second cluster of attributes corresponding to the other entity does not satisfy the audience definition criteria; and
based on determining that the second cluster of attributes does not satisfy the audience definition criteria, designating, by the processor, the respective cookies and MAIDS associated with the second cluster of attributes as not belonging to the target audience.

12. The method of claim 7, wherein the audience definition criteria includes one or more logic statements defining one or more attributes of the target audience.

13. A non-transitory computer-readable medium comprising program code that is executable by a processor for causing the processor to:
determine a first set of attributes corresponding to a first unique identifier associated with an entity;
determine a second set of attributes corresponding to a second unique identifier associated with the entity;
generate a cluster of attributes for the entity based on the first set of attributes and the second set of attributes;
receive a request from a client device, the request being associated with the entity accessing a webpage;
determine that the cluster of attributes corresponds to the entity;
based on determining that the cluster of attributes corresponds to the entity, determine whether the cluster of attributes satisfies audience definition criteria defining a target audience for content; and
transmit a response to the client device indicating whether the entity belongs to the target audience to allow or prevent the content from being transmitted to the entity.

14. The non-transitory computer-readable medium of claim 13, wherein the first unique identifier is of a first type and the second unique identifier is of a second type that is different than the first type.

15. The non-transitory computer-readable medium of claim 14, wherein the first type is a cookie and the second type is a MAID.

16. The non-transitory computer-readable medium of claim 13, further comprising program code that is executable by the processor for causing the processor to:
determine a plurality of unique identifiers corresponding to the cluster of attributes, the plurality of unique identifiers including the first unique identifier and the second unique identifier; and
in response to determining that the cluster of attributes satisfies the audience definition criteria, designate all of the unique identifiers in the plurality of unique identifiers as belonging to the target audience.

17. The non-transitory computer-readable medium of claim 13, further comprising program code that is executable by the processor for causing the processor to:
determine a plurality of unique identifiers corresponding to the cluster of attributes, the plurality of unique identifiers including the first unique identifier and the second unique identifier; and
in response to determining that the cluster of attributes does not satisfy the audience definition criteria, designate all of the unique identifiers in the plurality of unique identifiers as not belonging to the target audience.

18. The non-transitory computer-readable medium of claim 13, further comprising program code that is executable by the processor for causing the processor to:
receive a plurality of clusters of attributes corresponding to a plurality of entities, wherein each cluster of attributes in the plurality of clusters of attributes corresponds to a respective entity in the plurality of entities and includes an aggregated set of attributes generated from subsets of attributes corresponding to respective unique identifiers associated with the respective entity, and wherein the plurality of clusters of attributes includes a first cluster of attributes corresponding to the entity and a second cluster of attributes corresponding to another entity;
analyze each cluster of attributes in the plurality of clusters of attributes to determine whether the cluster of attributes satisfies the audience definition criteria; and
based on analyzing each cluster of attributes in the plurality of clusters of attributes:
determine whether the second cluster of attributes corresponding to the other entity does not satisfy the audience definition criteria; and
based on determining that the second cluster of attributes does not satisfy the audience definition criteria, designate the respective unique identifiers associated with the second cluster of attributes as not belonging to the target audience.

19. The non-transitory computer-readable medium of claim 13, wherein the audience definition criteria includes one or more logic statements defining one or more attributes of the target audience.

20. The non-transitory computer-readable medium of claim 13, wherein the audience definition criteria includes one or more logic statements defining one or more attributes of the target audience.
